(19) United States
(12) Patent Application Publication
(10) Pub. No.: US 2026/0026503 A1
(43) Pub. Date: Jan. 29, 2026

(54) COMPOUND WEEDING COMPOSITION FOR SUGARCANE FIELD

(71) Applicant: Guangxi University, Nanning (CN)

(72) Inventors: Muqing ZHANG, Nanning (CN); Zhengxia CHEN, Nanning (CN); Yixue BAO, Nanning (CN); Wei YAO, Nanning (CN); Hongtao JIANG, Nanning (CN)

(21) Appl. No.: 18/884,072

(22) Filed: Sep. 12, 2024

(30) Foreign Application Priority Data
Jul. 24, 2024 (CN) 202411000072.6

(51) Int. Cl. A01N 43/70; A01N 41/10; A01N 43/40; A01P 13/02

(52) U.S. Cl. CPC A01N 43/70; A01N 41/10; A01N 43/40; A01P 13/02

(57) ABSTRACT

The present disclosure provides a compound weeding composition for a sugarcane field. Active ingredients of the weeding composition are mesotrione, ametryn, and fluroxypyr-meptyl, and a weight ratio of the mesotrione to the ametryn to the fluroxypyr-meptyl is 1-50:1-70:1-50.

### TECHNICAL FIELD

The present disclosure relates to the technical field of pesticides, particularly a compound weeding composition for a sugarcane field.

### BACKGROUND

Sugarcane is the most critical sugar-yielding crop in China; sucrose's output accounts for 90% or above of the total sugar in China. The sugarcane industry is the main source of local finance in the main sugarcane-producing areas, and it is closely related to the employment and life of more than 10 million people in China. The sustainable and healthy development of the sugarcane industry plays a vital role in improving people's lives, promoting the development of agriculture and related industries, and even the development of the whole national economy.

Weeds are common in sugarcane fields, which compete with sugarcane for water, fertilizer, light energy, and other resources, and compete for growth space, affecting normal growth of sugarcane, causing sugarcane yield reduction and low yield, and causing considerable losses to sugarcane production. Broad-leaf weeds and gramineous weeds are common in sugarcane fields. Grass disaster seriously impacts the tillering and seedling growth of sugarcane, which reduces the yield of sugarcane by 30%-70% and has crop failure in severe cases. Further, weeds are the intermediate host of sugarcane diseases and pests and the hiding place of rats. Therefore, it is essential to use comprehensive control and elimination production practices as soon as possible. With the development of agricultural science and technology, the popularization and application of chemical herbicides have become decisive measures to increase production with high efficiency, convenience, labor saving, time saving, and cost saving. The chemical control of weeds in sugarcane fields is mostly concentrated in three key stages: sealing before germination after sowing, seedling and tillering stage after germination, and directional stem and leaf spraying is the primary measure to control the weeds.

At present, there are wide varieties of sugarcane herbicides, and the dosage forms are mainly wettable powder, soluble concentrate, emulsifiable concentrate, water dispersible granules, water aqua, an emulsion in water, and a suspending agent, a total of 7. According to the latest investigation, the herbicide sprayed on the stems and leaves after sprouting on sugarcane is mainly mesotrione, Ametryn, chlorimuron-ethyl, 2-methyl-4-chlorophenoxy acetic acid, cyanazine, triclopyr-butyl, etc. As a triketone herbicide, mesotrione is relatively safe for sugarcane, which can effectively control and eliminate annual broad-leaf weeds and some gramineous weeds. It has a pronounced control effect on nut grass and sedge weed. Still, compatibility is good because it has a poor control effect on Acalypha australis and some gramineous weeds such as Setaria viridis. Ametryn, as a widely used triazene herbicide, can effectively control annual and perennial broad-leaf weeds and gramineous weeds in sugarcane fields. It has the characteristics of low cost and high efficiency, and it is an excellent candidate for active ingredients in compound formulation at low price. The mixture of mesotrione and various herbicides has no antagonistic or synergistic effect, especially when mixed with Ametryn. However, the compounds mesotrione and Ametryn have been used for a long time, and crops have drug resistance problems. Therefore, the percentage of weed control of the binary compound product with mesotrione as the main component has been unable to satisfy the requirements of crop weeding. As a hormone herbicide, fluroxypyr-meptyl can effectively control and eliminate all broad-leaf weeds and is safe for crops. In the prior art, no related patent has reported the optimized proportion and synergistic effect of the three active ingredients.

Single herbicides control weeds in a single direction. Field weeds are likely to have drug resistance when used alone, and a mixture without a scientific basis wastes chemicals, increasing costs and failing to achieve the corresponding weeding effect. Therefore, it is urgent to combine the three herbicides scientifically to expand the weed control spectrum and reduce the frequency and amount of application.

### SUMMARY

In order to overcome the technical defects in the prior art, the present disclosure provides a weeding composition containing mesotrione. The combination of three active ingredients has an obvious synergistic effect, such that the amount of pesticide is reduced, cost and environmental pollution are reduced, and the application of the composition may delay drug resistance of weeds in a sugarcane field and expand a control and elimination spectrum.

In order to achieve the above objective, the present disclosure provides the following technical solution:

The compound weeding composition for a sugarcane field includes mesotrione, Ametryn, and fluroxypyr-meptyl.

A weight ratio of the mesotrione to the Ametryn to the fluroxypyr-meptyl is (1-50):(1-70):(1-50).

Optionally, the weight ratio of the mesotrione to the Ametryn to the fluroxypyr-meptyl is (2-10):(12-52):(4-20).

Optionally, the weight ratio of the mesotrione to the Ametryn to the fluroxypyr-meptyl is 8:22:(8-20).

Optionally, the weight ratio of the mesotrione to the Ametryn to the fluroxypyr-meptyl is 8:22:8.

Optionally, the compound weeding composition further includes auxiliary materials.

The auxiliary materials include at least one emulsifier, dispersant, wetting agent, speader, disintegrant, thickener, antifreeze, stabilizer, defoamer, synergist, penetrant, adhesive, safener, carrier, and filler.

Optionally, the compound weeding composition satisfies at least one of the following conditions:

The dispersant includes one or more of a mixture of polycarboxylate, lignosulfonate, alkyl naphthalene sulfonate, alkylphenol ethoxylate, EO/PO block polyether, polycarboxylate, alkylphenol polyoxyethylene ether formaldehyde condensate and a mixture of maleic rosin polypropylene-oxyethylene ether sulfonate.

The wetting agent includes one or more of a mixture of sodium dodecyl sulfate, fatty alcohol-polyoxyethylene ether, phenyl ethyl phenol polyoxyethylene ether phosphate, alkylphenol ethoxylate phosphate ester, alkyl sulfate, sodium alkylbenzene sulfonate, sodium lauryl sulfate, sodium butyl naphthalene sulphonate, fatty alcohol-polyoxyethylene ether, alkylphenol ethoxylate, alkane sulfonate, octaphenyl polyoxyethylene and sodium diethylhexyl sulfosuccinate.

The disintegrant includes one or more of a mixture of ammonium sulfate, sodium sulfate, sodium chloride, ammonium chloride, urea, sucrose, glucose, carboxymethyl cellulose, soluble starch, and polyvinylpyrrolidone.

The adhesive includes one or more mixtures of polyvinyl alcohol, gel, xanthan gum, and carboxymethyl cellulose.

The emulsifier includes one or more of a mixture of alkylphenol formaldehyde resin polyoxyethylene ether, castor oil polyoxyethylene ether, pesticide emulsifier 2201, sorbitan monostearate, polyoxyethylene sorbitan monostearate, a triphenyl ethyl phenol polyoxypropylene block polymer, phenyl ethyl phenol polyoxyethylene ether, SND-1 and SND-2.

The thickener includes one or more of a mixture of xanthan gum, gel, polyvinyl alcohol, magnesium aluminosilicate, sodium alginate, white carbon black, organobentonite, M, and FT.

The antifreeze includes one or more mixtures of ethylene glycol, glycerol, polyethylene glycol, urea, sorbitol, and inorganic salts.

The defoamer includes one or more of a mixture of silicone defoamers.

The filler includes one or more of a mixture of ammonium sulfate, urea, sucrose, glucose, diatomite, kaolin, white carbon black, light calcium carbonate, talcum powder, bentonite, attapulgite, and pottery clay.

The vegetable oil includes one or more of a mixture of soybean oil, sugarcane oil, rapeseed oil, cottonseed oil, palm oil, castor oil, corn oil, sunflower oil, isooctyl oleate, methyl oleate, and paraffin oil.

Optionally, the dosage form of the compound weeding composition is at least one of suspension concentrates, oil dispersion, wettable powder, or water-dispersible granules.

Optionally, the compound weeding composition is prepared by storing all components in a pesticide composition, forming the active ingredient, and mixing the components in a barrel separately for usage.

The present disclosure further provides the application of the compound weeding composition for a sugarcane field as a product and herbicide directly in pesticides.

Compared with the prior art, the present disclosure includes the following beneficial effects:

First, the compound weeding composition for a sugarcane field provided by the present disclosure may effectively control and eliminate weeds in the sugarcane field under a specific system of the present disclosure by compounding the mesotrione, the Ametryn, the fluroxypyr-meptyl, additives, the filler, and the solvent. The present disclosure has an obvious control and eliminating effect on gramineous weeds such as barnyard grass, crabgrass, Setaria viridis, and Paspalum distichum, broad-leaf weeds such as railway beggarticks, oxalis, Spermacoce latifolia, Alisma orientale and Alternanthera philoxeroides, and Cyperaceae weeds as Cyperus difformis and Cyperus iria, and compared with the single use of the mesotrione, the using amount is reduced, a weeding effect is improved, and the effect of reducing a cost and increasing efficiency is achieved.

Second, the mesotrione, the Ametryn, and the fluroxypyr-meptyl may play a significant synergistic role in the specific proportion of the present disclosure, and a control effect on various weeds is 90% or above, such that a novel cost-saving and synergistic ternary compound herbicide for weeding sugarcane fields is provided.

### BRIEF DESCRIPTION OF THE DRAWINGS

In order to describe the technical solutions in the embodiments of the present disclosure more clearly, the accompanying drawings required by the embodiments are briefly described below. It should be understood that the accompanying drawings bellow show merely some embodiments of the present disclosure and, therefore, should not be regarded as limiting the scope, and a person of ordinary skill in the art would also be able to derive other related accompanying drawings from these accompanying drawings without creative efforts.

FIG. 1A is a diagram showing the effect of Embodiment 1 before spraying.

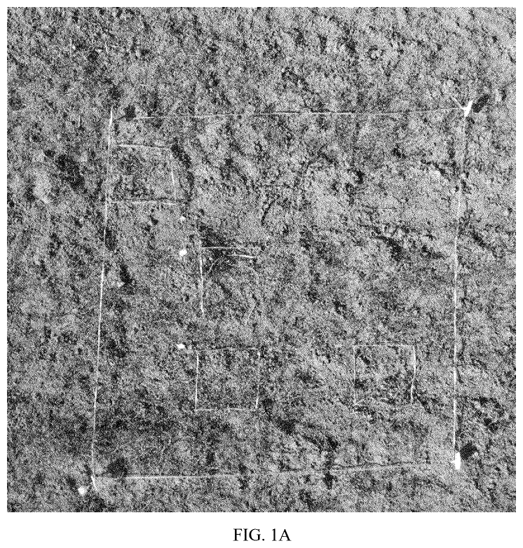

FIG. 1B is a diagram showing the effect of spraying mesotrione, Ametryn, and fluroxypyr-meptyl after compounding for 12 d in Embodiment 1.

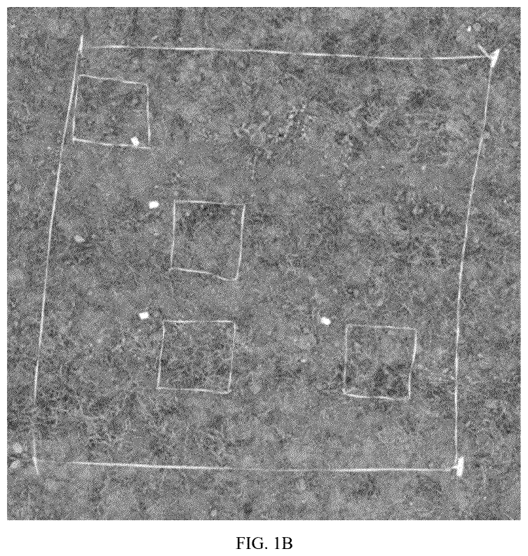

FIG. 1C is a diagram showing the effect of spraying the mesotrione, the Ametryn, and the fluroxypyr-meptyl after compounding for 25 d in Embodiment 1.

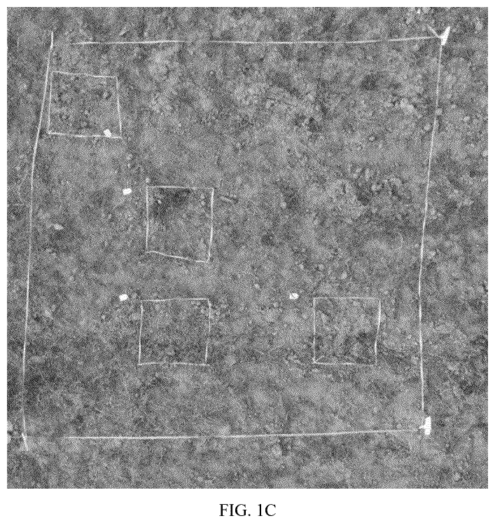

FIG. 2A is a diagram showing the effect of Comparative Example 1 before spraying.

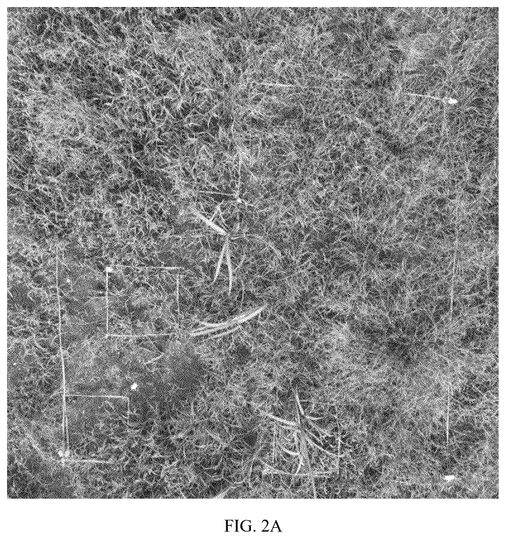

FIG. 2B is a diagram showing the effect of spraying the mesotrione and the Ametryn for 7 d in Comparative Example 1.

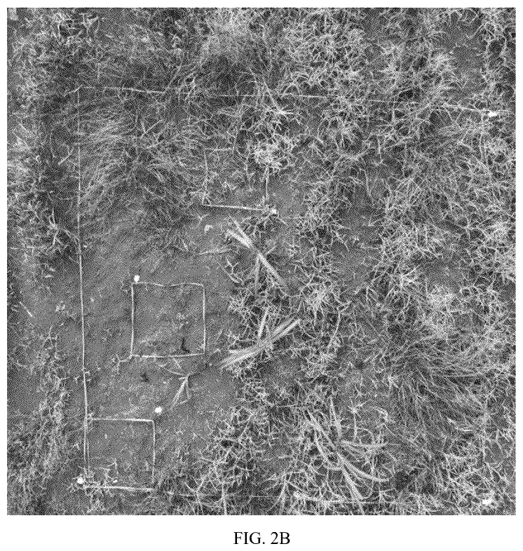

FIG. 2C is a diagram showing the effect of spraying the mesotrione and the Ametryn for 15 d in Comparative Example 1.

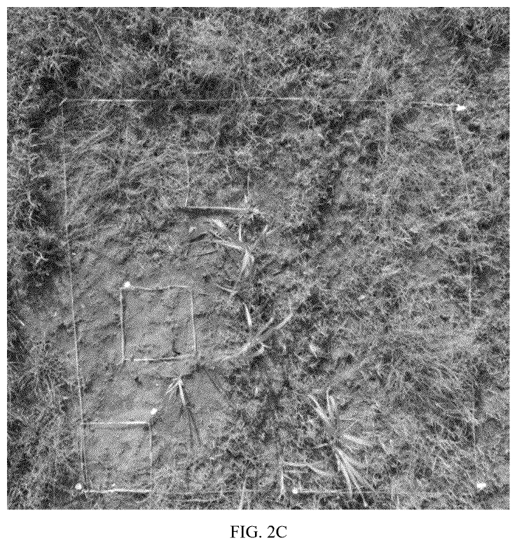

### DETAILED DESCRIPTION OF THE EMBODIMENTS

The present disclosure concerning specific embodiments will be further described below. What are described below are only some embodiments of the present disclosure and are not intended to limit the present disclosure in any form. Although the present disclosure has been disclosed below with the preferred embodiments, they are not intended to limit the present disclosure. Any person skilled in the art should be able to make some changes or modifications equivalent to equivalent implementation cases by using the technical contents disclosed above without departing from the scope of the technical solution of the present disclosure, which falls within the scope of the technical solution of the present disclosure.

Unless otherwise specified, the raw materials in the embodiments of the present disclosure are all purchased through commercial channels and used directly without any special treatment.

Unless otherwise specified, the analytical methods in the embodiments all use conventional instrument or apparatus settings and analytical methods.

In the following embodiments, mesotrione is purchased from Jiangsu Good Harvest-Weien Agrochemical Co., Ltd.

In the following embodiments, Ametryn is purchased from Shandong Weifang Rainbow Chemical CO., Ltd.

A fluroxypyr-meptyl technical material is purchased from Zhejiang Tianfeng Bioscience Co., Ltd in the following embodiments.

### Embodiment 1

### 1.1. Preparation of Single Herbicides:

Mesotrione: A mesotrione technical material with a content of 97% is prepared, and emulsifiers SND-1 (with a content of 9.3%) and SND-2 (with a content of 4.7%) are mixed with methyl oleate (total quantity of 70%) in a mixing kettle for 1 h according to a proportion and using amounts. After that, thickener M (with a content of 2%) is added into the mixing kettle, and then the methyl oleate (total quantity of 30%) is slowly added in a stirring process and uniformly mixed for 1 h. The mesotrione technical material (with a content of 35%), defoamer (with a content of 0.1%), and the above two mixed solutions are added into the mixing kettle and mixed for 1 h. Grinding is performed in a sand mill for 2.5 h according to a material ratio of 1:1.2, and a suspending agent with a mass percentage content of 15% can be prepared.

Ametryn: An Ametryn technical material with a content of 96.5% is prepared, 36.25 g of several parts of Ametryn technical material is weighed, 4 g of dispersant (maleic rosin polypropylene-oxyethylene ether sulfonate, SC-3), 2 g of antifreeze (ethylene glycol) and 2 g of thickener (FT) are added separately, the quantity is made up to 100 g with deionized water, mixing and sizing are performed, and all materials can be wetted and flow. Firstly, pre-dispersion is performed with a high-shear emulsifying machine; then, the slurry is moved into the sand mill and ground under the cooling condition for 4 h, and an Ametryn suspension concentrate with a mass percentage content of 35% is obtained.

Fluroxypyr-meptyl: A fluroxypyr-meptyl technical material with a content of 97% is prepared, fluroxypyr-meptyl with a content of 36%, pesticide emulsifier 500# with a content of 8%, OP-10P with a content of 4%, Atlox 4894 # with a content of 5% and organobentonite with a content of 0.5% are made up to 100% with methyl oleate and soybean oil at volume ratio of 4:1. According to a conventional preparation method, a suspending agent with a mass percentage content of 36% is prepared.

### 1.2. Effect Determination

Objective: In order to know the synergistic effect of the mesotrione, the Ametryn, and the fluroxypyr-meptyl after compounding and to expand a weed-eliminate spectrum of single herbicides, the experiment is performed with the using amounts reduced.

General situation of a test field: The experiment is performed by being arranged in the Nongqin sugarcane field in Fusui County, Chongzuo City; soil fertility is uniform, the field is ploughed, seeds of tested weeds are uniformly sown in the field, watered, and covered with fine sand having a thickness of 0.5-1 cm, then a mulch film is attached to the field for culture. After the weeds grew, the mulch film is uncovered, and plots are divided, each plot covered an area of 16 m², each plot is provided with four replicates, each replicate is 1 m², the replicates are randomly arranged, and each replicate included six types of weeds of nut grass, crabgrass, bermudagrass, Spermacoce latifolia, morning glory and Merremia hederacea, which are uniformly distributed.

Concentration formula: a binary compound preparation of the mesotrione and the ametryn, a single fluroxypyr-meptyl herbicide, and a mixed preparation of the three are set with 5 dose gradients according to an equal ratio sequence, a blank control is arranged, and each experimental treatment is repeated for 4 times. Table 1 shows the dosage of treatment agents.

TABLE 1
Test treatment and test level (concentration g.a.i/kg)

| | | | | (A + B):C | (A + B):C | (A + B):C | (A + B):C | (A + B):C |
|---|---|---|---|---|---|---|---|---|
| Herbicide | Treatment | A + B | C | 32:4 | 30:8 | 28:12 | 26:16 | 24:20 |
| Mesotrione A | 1 | 0.075 | 0.028125 | 0.009375 | 0.009375 | 0.009375 | 0.009375 | 0.009375 |
| Ametryn B | 2 | 0.15 | 0.05625 | 0.01875 | 0.01875 | 0.01875 | 0.01875 | 0.01875 |
| Fluroxypyr-meptyl | 3 | 0.3 | 0.1125 | 0.0375 | 0.0375 | 0.0375 | 0.0375 | 0.0375 |
| C | 4 | 0.6 | 0.225 | 0.75 | 0.75 | 0.75 | 0.75 | 0.75 |
| | 5 | 1.2 | 0.45 | 1.5 | 1.5 | 1.5 | 1.5 | 1.5 |

Application method: The above-prepared technical material solutions are compounded and diluted into liquid medicine with a certain concentration gradient. When the weeds grow to a 3-5-leaf stage, stems and leaves are sprayed with 3 ml of liquid medicine for each plot, and a blank solution is used as a control.

1.3. Experimental investigation: After treatment, the weeds' growth is observed regularly. Four points are randomly sampled in each plot on day 12 and day 25 after application, with 1 m² taken from each point. The species and number of weeds are investigated and recorded separately. The fresh weight of the weeds is weighed in the last investigation, and a plant control effect and a fresh weight control effect are calculated.

1.4. Tables 2-5 show results and analysis.

TABLE 2
Plant control effect 12 d after application

| | | Mesotrione + | Fluroxypyr- | | | | | |
|---|---|---|---|---|---|---|---|---|
| | | Ametryn | meptyl | 32:4 | 30:8 | 28:12 | 26:16 | 24:20 |
| | | Plant | Plant | Plant | Plant | Plant | Plant | Plant |
| | | control | control | control | control | control | control | control |
| Weed | Treatment | effect | effect | effect | effect | effect | effect | effect |
| Nut grass | 1 | 2.25 | 3.57 | 0.00 | 12.50 | 8.96 | 15.09 | 7.61 |
| | 2 | 7.28 | 1.28 | 2.00 | 14.75 | 23.42 | 18.75 | 2.00 |
| | 3 | 13.59 | 2.73 | 15.94 | 13.51 | 47.73 | 23.08 | 17.54 |
| | 4 | 16.00 | 1.54 | 62.75 | 70.59 | 64.44 | 50.77 | 73.57 |
| | 5 | 58.99 | 9.80 | 81.44 | 82.43 | 96.39 | 90.00 | 78.85 |
| Crabgrass | 1 | 0.00 | 0.00 | 100.00 | 57.14 | 100.00 | 100.00 | 100.00 |
| | 2 | 0.00 | 0.00 | 100.00 | 62.50 | 100.00 | 100.00 | 100.00 |
| | 3 | 42.86 | 0.00 | 100.00 | 100.00 | 100.00 | 100.00 | 100.00 |
| | 4 | 80.00 | 0.00 | 100.00 | 100.00 | 100.00 | 100.00 | 100.00 |
| | 5 | 85.12 | 5.76 | 100.00 | 100.00 | 100.00 | 100.00 | 100.00 |
| Bermudagrass | 1 | 0.00 | 0.00 | 0.00 | 18.97 | 27.78 | 0.00 | 0.00 |
| | 2 | 0.00 | 0.00 | 2.25 | 37.50 | 50.00 | 15.69 | 0.00 |
| | 3 | 25.00 | 0.00 | 10.00 | 83.33 | 34.49 | 59.37 | 32.00 |
| | 4 | 73.33 | 0.00 | 100.00 | 84.20 | 85.79 | 47.11 | 83.33 |
| | 5 | 100.00 | 0.00 | 100.00 | 100.00 | 100.00 | 100.00 | 100.00 |
| Morning glory | 1 | 5.56 | 0.00 | 45.16 | 47.06 | 47.06 | 18.75 | 27.27 |
| | 2 | 3.23 | 0.00 | 55.00 | 50.00 | 69.23 | 87.10 | 67.35 |
| | 3 | 15.79 | 0.00 | 69.23 | 83.33 | 76.60 | 96.67 | 100.00 |
| | 4 | 35.48 | 8.33 | 69.57 | 92.50 | 100.00 | 100.00 | 100.00 |
| | 5 | 28.00 | 0.00 | 100.00 | 100.00 | 100.00 | 100.00 | 100.00 |
| Spermacoce | 1 | 0.00 | 0.00 | 0.00 | 0.00 | 0.00 | 0.00 | 0.00 |
| latifolia | 2 | 0.00 | 0.00 | 0.00 | 0.00 | 0.00 | 0.00 | 0.00 |
| | 3 | 0.00 | 0.00 | 0.00 | 16.00 | 0.00 | 0.00 | 0.00 |
| | 4 | 0.00 | 0.00 | 0.00 | 42.42 | 38.46 | 0.00 | 10.00 |
| | 5 | 0.00 | 0.00 | 70.97 | 50.00 | 33.33 | 50.00 | 50.00 |
| Merremia | 1 | 0.00 | 0.00 | 0.00 | 50.00 | 50.00 | 0.00 | 0.00 |
| hederacea | 2 | 12.50 | 0.00 | 25.00 | 100.00 | 100.00 | 80.00 | 100.00 |
| | 3 | 43.57 | 0.00 | 100.00 | 100.00 | 100.00 | 100.00 | 100.00 |
| | 4 | 57.21 | 0.00 | 100.00 | 100.00 | 100.00 | 100.00 | 100.00 |
| | 5 | 66.67 | 0.00 | 100.00 | 100.00 | 100.00 | 100.00 | 100.00 |

TABLE 3
Plant control effect 25 d after application

| | | Mesotrione + | Fluroxypyr- | | | | | |
|---|---|---|---|---|---|---|---|---|
| | | Ametryn | meptyl | 32:4 | 30:8 | 28:12 | 26:16 | 24:20 |
| | | Plant | Plant | Plant | Plant | Plant | Plant | Plant |
| | | control | control | control | control | control | control | control |
| Weed | Treatment | effect | effect | effect | effect | effect | effect | effect |
| Nut grass | 1 | 84.27 | 59.52 | 68.75 | 56.94 | 79.55 | 62.26 | 59.00 |
| | 2 | 68.87 | 67.31 | 57.00 | 54.10 | 83.54 | 81.25 | 77.17 |
| | 3 | 53.40 | 79.09 | 71.01 | 56.76 | 71.64 | 80.00 | 87.72 |
| | 4 | 76.00 | 76.92 | 82.35 | 93.46 | 97.78 | 92.31 | 96.15 |
| | 5 | 94.24 | 82.35 | 97.94 | 98.65 | 100.00 | 98.57 | 100.00 |
| Crabgrass | 1 | 44.83 | 0.00 | 100.00 | 87.50 | 100.00 | 100.00 | 100.00 |
| | 2 | 50.46 | 0.00 | 100.00 | 100.00 | 100.00 | 100.00 | 100.00 |
| | 3 | 80.00 | 0.00 | 100.00 | 100.00 | 100.00 | 100.00 | 100.00 |
| | 4 | 85.71 | 0.00 | 100.00 | 100.00 | 100.00 | 100.00 | 100.00 |
| | 5 | 86.92 | 36.46 | 100.00 | 100.00 | 100.00 | 100.00 | 100.00 |
| Bermudagrass | 1 | 20.00 | 0.00 | 0.00 | 14.90 | 27.78 | 1.48 | 0.00 |
| | 2 | 60.00 | 0.00 | 0.00 | 37.50 | 50.00 | 15.69 | 0.00 |
| | 3 | 99.33 | 13.69 | 20.00 | 28.89 | 53.46 | 48.45 | 25.01 |
| | 4 | 100.00 | 34.29 | 100.00 | 100.00 | 89.47 | 75.48 | 100.00 |
| | 5 | 100.00 | 100.00 | 100.00 | 100.00 | 100.00 | 100.00 | 100.00 |
| Morning glory | 1 | 83.33 | 57.89 | 96.77 | 100.00 | 94.12 | 97.92 | 100.00 |
| | 2 | 74.19 | 58.06 | 100.00 | 100.00 | 100.00 | 100.00 | 93.88 |
| | 3 | 100.00 | 51.85 | 100.00 | 100.00 | 100.00 | 100.00 | 100.00 |
| | 4 | 100.00 | 58.33 | 100.00 | 100.00 | 100.00 | 100.00 | 100.00 |
| | 5 | 96.00 | 87.50 | 100.00 | 100.00 | 100.00 | 100.00 | 100.00 |
| Spermacoce | 1 | 0.00 | 23.08 | 80.00 | 76.67 | 84.62 | 93.33 | 100.00 |
| latifolia | 2 | 23.58 | 44.44 | 87.50 | 100.00 | 84.62 | 100.00 | 100.00 |
| | 3 | 57.89 | 57.45 | 96.15 | 100.00 | 100.00 | 100.00 | 100.00 |
| | 4 | 42.78 | 65.27 | 100.00 | 100.00 | 90.91 | 100.00 | 100.00 |
| | 5 | 70.54 | 80.24 | 100.00 | 100.00 | 100.00 | 100.00 | 100.00 |
| Merremia | 1 | 87.50 | 0.00 | 100.00 | 50.00 | 100.00 | 80.00 | 100.00 |
| hederacea | 2 | 100.00 | 33.33 | 100.00 | 100.00 | 100.00 | 100.00 | 100.00 |
| | 3 | 100.00 | 100.00 | 100.00 | 100.00 | 100.00 | 100.00 | 100.00 |
| | 4 | 100.00 | 100.00 | 100.00 | 100.00 | 100.00 | 100.00 | 100.00 |
| | 5 | 100.00 | 100.00 | 100.00 | 100.00 | 100.00 | 100.00 | 100.00 |

TABLE 4
Fresh weight control effect 25 d after application

| | Mesotrione + | Fluroxypyr- | | | | | |
|---|---|---|---|---|---|---|---|
| | ametryn | meptyl | 32:4 | 30:8 | 28:12 | 26:16 | 24:20 |
| | Fresh | Fresh | Fresh | Fresh | Fresh | Fresh | Fresh |
| | weight | weight | weight | weight | weight | weight | weight |
| | control | control | control | control | control | control | control |
| Treatment | effect | effect | effect | effect | effect | effect | effect |
| 1 | 67.04 | 49.44 | 74.00 | 53.12 | 84.65 | 74.00 | 73.80 |
| 2 | 67.25 | 68.47 | 76.46 | 79.53 | 85.06 | 76.87 | 81.58 |
| 3 | 78.71 | 68.47 | 84.85 | 85.47 | 89.56 | 83.42 | 88.54 |
| 4 | 81.78 | 71.14 | 91.20 | 89.15 | 94.27 | 85.06 | 94.68 |
| 5 | 88.74 | 75.64 | 91.20 | 89.76 | 95.70 | 90.79 | 94.68 |

It can be seen from the above tables that the mesotrione, the ametryn and the fluroxypyr-meptyl after compounding have an obvious synergistic effect compared with using of the single herbicides. An optimal ratio of the mesotrione to the ametryn to the fluroxypyr-meptyl is 8:22:8-20.

TABLE 5
Economic benefit evaluation of active ingredients of medicine (Unit: Yuan/667 m²)

| | Mesotrione | Ametryn | Fluroxypyr-meptyl | 32:4 | 30:8 | 28:12 | 26:16 | 24:20 |
|---|---|---|---|---|---|---|---|---|
| Level | A | B | C | (A + B):C | (A + B):C | (A + B):C | (A + B):C | (A + B):C |
| 1 | 0.090 | 0.124 | 0.120 | 0.028 | 0.030 | 0.031 | 0.032 | 0.033 |
| 2 | 0.180 | 0.248 | 0.240 | 0.056 | 0.059 | 0.061 | 0.064 | 0.066 |
| 3 | 0.360 | 0.495 | 0.481 | 0.113 | 0.118 | 0.123 | 0.127 | 0.131 |
| 4 | 0.720 | 0.990 | 0.962 | 2.256 | 2.363 | 2.458 | 2.545 | 2.623 |
| 5 | 1.440 | 1.980 | 1.924 | 4.513 | 4.725 | 4.916 | 5.089 | 5.247 |

Economic benefit is also the most important factor when prioritizing a weeding effect and crop safety by a new ternary herbicide, and cost performance is a primary factor in a market purchase rate. The mainstream herbicide price (a preparation cost) is generally 3.5-7.5 yuan/mu. In Table 5, Level 5 is the treatment showing the best control effect, with the highest price of 5.247 yuan/mu, which is lower than the highest market price. A control effect of Level 4 also reaches 95% or above, and the highest price is 2.623 yuan/mu, which is lower than the lowest market price. The above results show that the screened new herbicide has high-cost performance.

Therefore, the optimum ratio of the mesotrione to the Ametryn to the fluroxypyr-meptyl is 8:22:8, which achieves the best cost performance.

### Comparative Example 1

Compared with Embodiment 1, the only difference is that fluroxypyr-meptyl is not added, and other conditions are the same as those in Example 1, with the specific operations as follows:

### 1.1. Preparation of Single Herbicides:

Mesotrione: A mesotrione technical material with a content of 97% is prepared, and emulsifiers SND-1 (with a content of 9.3%) and SND-2 (with a content of 4.7%) are mixed with methyl oleate (total quantity of 70%) in a mixing kettle for 1 h according to a proportion and using amounts. After that, thickener M (with a content of 2%) is added into the mixing kettle, and then the methyl oleate (total quantity of 30%) is slowly added in a stirring process and uniformly mixed for 1 h. The mesotrione technical material (with a content of 35%), defoamer (with a content of 0.1%), and the above two mixed solutions are added into the mixing kettle and mixed for 1 h. Grinding is performed in a sand mill for 2.5 h according to a material ratio of 1:1.2, and a suspending agent with a mass percentage content of 15% can be prepared.

Ametryn: An Ametryn technical material with a content of 96.5% is prepared, 36.25 g of several parts of Ametryn technical material is weighed, 4 g of dispersant (maleic rosin polypropylene-oxyethylene ether sulfonate, SC-3), 2 g of antifreeze (ethylene glycol) and 2 g of thickener (FT) are added separately, the quantity is made up to 100 g with deionized water, mixing and sizing are performed, and all materials are able to be wetted and flow. Firstly, pre-dispersion is performed with a high-shear emulsifying machine; then, the slurry is moved into the sand mill and ground under the cooling condition for 4 h, and an Ametryn suspension concentrate with a mass percentage content of 35% is obtained.

### 1.2. Test Design

Objective: In order to know the synergistic effect of the mesotrione and the ametryn after compounding and to expand an eliminated spectrum of single herbicides, the amount is reduced, and the experiment is performed to provide theoretical support for the scientific compounding of ternary herbicides.

General situation of a test field: The experiment is performed by being arranged in the Nongqin sugarcane field in Fusui County, Chongzuo City, soil fertility is uniform, the field is ploughed, seeds of tested weeds are uniformly sown in the field, watered, and covered with fine sand having a thickness of 0.5-1 cm, then a mulch film is attached to the field for culture. After the weeds grew, the mulch film is uncovered, and plots are divided, each plot covered an area of 16 m², each plot is provided with four replicates, each replicate is 1 m², the replicates are randomly arranged, and each replicate included three types of weeds of crabgrass, barnyard grass, and nut grass, which are uniformly distributed.

Concentration formula: A single mesotrione herbicide, a single ametryn herbicide, and a binary mixed preparation are set with five dose gradients according to an equal ratio sequence, a blank control is arranged, and each experimental treatment is repeated four times. Table 6 shows the dosage of treatment agents.

TABLE 6
Test treatment and test level (concentration g.a.i/kg)

| Horizontal | Mesotrione | Ametryn | A:B | A:B | A:B | A:B | A:B |
|---|---|---|---|---|---|---|---|
| treatment | A | B | 2:52 | 4:42 | 6:32 | 8:22 | 10:12 |
| 1 | 0.17 | 0.125 | 0.075 | 0.075 | 0.075 | 0.075 | 0.075 |
| 2 | 0.33 | 0.25 | 0.15 | 0.15 | 0.15 | 0.15 | 0.15 |
| 3 | 0.67 | 0.5 | 0.3 | 0.3 | 0.3 | 0.3 | 0.3 |
| 4 | 1.33 | 1 | 0.6 | 0.6 | 0.6 | 0.6 | 0.6 |
| 5 | 2.67 | 2 | 1.2 | 1.2 | 1.2 | 1.2 | 1.2 |

Application method: The above-prepared technical material solutions are compounded and diluted into liquid medicine with a certain concentration gradient. When the weeds grow to a 3-5-leaf stage, stems and leaves are sprayed with 3 ml of liquid medicine for each plot, and a blank solution is used as a control.

1.3. Experimental investigation: After treatment, the weeds' growth is observed regularly. Four points are randomly sampled in each plot on day 7 and day 15 after application, with 1 m² taken from each point. The species and number of weeds are investigated and recorded separately. The fresh weight of the weeds is weighed in the last investigation, and a plant control effect and a fresh weight control effect are calculated.

1.4. Tables 7-9 show results and analysis.

TABLE 7
Plant control effect 7 d after application

| | | Mesotrione | Ametryn | 2:52 | 4:42 | 6:32 | 8:22 | 10:12 |
|---|---|---|---|---|---|---|---|---|
| | | Plant | Plant | Plant | Plant | Plant | Plant | Plant |
| | | control | control | control | control | control | control | control |
| Weed | Treatment | effect | effect | effect | effect | effect | effect | effect |
| Nut grass | 1 | 7.18 | 1.03 | 4.88 | 16.96 | 25.48 | 34.21 | 42.01 |
| | 2 | 33.84 | 2.67 | 8.11 | 26.76 | 42.22 | 34.15 | 74.29 |
| | 3 | 66.40 | 2.79 | 14.29 | 40.31 | 46.27 | 46.99 | 81.82 |
| | 4 | 88.02 | 3.08 | 49.73 | 40.91 | 57.95 | 61.74 | 90.61 |
| | 5 | 85.92 | 5.62 | 51.22 | 61.32 | 72.12 | 95.00 | 89.44 |
| Crabgrass | 1 | 0.00 | 9.38 | 0.00 | 0.00 | 5.26 | 21.43 | 33.33 |
| | 2 | 0.00 | 25.00 | 5.88 | 55.56 | 25.00 | 28.57 | 50.00 |
| | 3 | 8.70 | 36.84 | 38.46 | 75.00 | 52.17 | 85.71 | 73.33 |
| | 4 | 12.50 | 70.00 | 96.15 | 93.33 | 61.54 | 88.89 | 100.00 |
| | 5 | 21.43 | 80.00 | 100.00 | 100.00 | 100.00 | 100.00 | 100.00 |
| Barnyard | 1 | 0.00 | 0.00 | 0.00 | 50.00 | 14.29 | 25.67 | 25.00 |
| grass | 2 | 0.00 | 15.00 | 0.00 | 66.67 | 50.00 | 60.43 | 66.67 |
| | 3 | 0.00 | 26.82 | 0.00 | 83.33 | 80.56 | 85.64 | 100.00 |
| | 4 | 16.67 | 60.00 | 60.00 | 89.54 | 100.00 | 100.00 | 100.00 |
| | 5 | 40.00 | 70.12 | 75.00 | 94.24 | 100.00 | 100.00 | 100.00 |

TABLE 8
Plant control effect 15 d after application

| | | Mesotrione | Ametryn | 2:52 | 4:42 | 6:32 | 8:22 | 10:12 |
|---|---|---|---|---|---|---|---|---|
| | | Plant | Plant | Plant | Plant | Plant | Plant | Plant |
| | | control | control | control | control | control | control | control |
| Weed | Treatment | effect | effect | effect | effect | effect | effect | effect |
| Nut grass | 1 | 12.71 | 9.28 | 10.98 | 21.05 | 28.89 | 42.11 | 47.34 |
| | 2 | 47.47 | 6.22 | 15.32 | 32.39 | 35.03 | 50.00 | 82.20 |
| | 3 | 80.27 | 5.67 | 22.45 | 52.71 | 65.67 | 53.01 | 83.67 |
| | 4 | 81.36 | 10.00 | 46.52 | 53.31 | 73.08 | 67.11 | 91.70 |
| | 5 | 88.37 | 28.09 | 50.76 | 58.49 | 90.91 | 95.00 | 96.48 |
| Crabgrass | 1 | 14.29 | 6.25 | 0.00 | 11.11 | 5.26 | 35.71 | 73.33 |
| | 2 | 19.05 | 16.67 | 53.85 | 61.11 | 68.75 | 71.43 | 100.00 |
| | 3 | 69.57 | 60.00 | 60.45 | 81.25 | 92.31 | 100.00 | 91.67 |
| | 4 | 82.86 | 73.68 | 92.31 | 100.00 | 100.00 | 94.44 | 100.00 |
| | 5 | 87.50 | 80.00 | 100.00 | 93.33 | 100.00 | 100.00 | 100.00 |
| Barnyard | 1 | 12.00 | 0.00 | 0.00 | 66.67 | 0.00 | 45.67 | 75.00 |
| grass | 2 | 50.00 | 20.12 | 100.00 | 75.00 | 100.00 | 70.43 | 83.33 |
| | 3 | 70.00 | 30.64 | NA | 76.67 | 100.00 | 85.64 | 100.00 |
| | 4 | 75.26 | 50.00 | 100.00 | 83.33 | 100.00 | 95.23 | 100.00 |
| | 5 | 80.27 | 85.42 | 100.00 | 100.00 | 100.00 | 100.00 | 100.00 |

TABLE 9
Fresh weight control effect 15 d after application

| | Mesotrione | Ametryn | 2:52 | 4:42 | 6:32 | 8:22 | 10:12 |
|---|---|---|---|---|---|---|---|
| | Fresh | Fresh | Fresh | Fresh | Fresh | Fresh | Fresh |
| | weight | weight | weight | weight | weight | weight | weight |
| | control | control | control | control | control | control | control |
| Treatment | effect | effect | effect | effect | effect | effect | effect |
| 1 | 54.05 | 52.86 | 88.94 | 81.72 | 79.68 | 88.36 | 90.29 |
| 2 | 68.76 | 72.70 | 88.94 | 93.31 | 86.61 | 93.78 | 90.45 |
| 3 | 80.71 | 75.36 | 82.29 | 95.49 | 97.46 | 91.48 | 87.53 |
| 4 | 88.70 | 87.16 | 84.02 | 94.86 | 96.66 | 93.91 | 96.09 |
| 5 | 81.19 | 95.16 | 93.93 | 96.21 | 98.53 | 94.38 | 95.73 |

It can be seen from the above Tables 7-9 that in Comparative Example 1, the mesotrione and the ametryn after compounding have an obvious synergistic effect compared with using of the single herbicides. However, compared with Embodiment 1, the synergistic effect could be better.

What are described above are only the preferred embodiments of the present disclosure and are not intended to limit the present disclosure in any form. Although the present disclosure has been disclosed above with the preferred embodiments, they are not intended to limit the present disclosure. Any person skilled in the art should be able to make equivalent embodiments of equivalent alterations by using the technical contents disclosed above with some alterations or modifications without departing from the scope of the technical solution of the present disclosure, but any brief modification, equivalent alterations, and modifications of the above embodiments according to the technical essence of the present disclosure still fall within the scope of the technical solution of the present disclosure.

What is claimed is:

1. A compound weeding composition for a sugarcane field, comprising mesotrione, ametryn, and fluroxypyr-meptyl, wherein
a weight ratio of the mesotrione to the ametryn to the fluroxypyr-meptyl is (1-50):(1-70):(1-50).

2. The compound weeding composition for a sugarcane field according to claim 1, wherein the weight ratio of the mesotrione to the ametryn to the fluroxypyr-meptyl is (2-10):(12-52):(4-20).

3. The compound weeding composition for a sugarcane field according to claim 2, wherein the weight ratio of the mesotrione to the ametryn to the fluroxypyr-meptyl is 8:22:(8-20).

4. The compound weeding composition for a sugarcane field according to claim 3, wherein the weight ratio of the mesotrione to the ametryn to the fluroxypyr-meptyl is 8:22:8.

5. The compound weeding composition for a sugarcane field according to claim 1, further comprising auxiliary materials; wherein
the auxiliary materials comprise at least one of an emulsifier, dispersant, a wetting agent, speader, disintegrant, a thickener, antifreeze, a stabilizer, defoamer, synergist, penetrant, adhesive, safener, a carrier, and a filler.

6. The compound weeding composition for a sugarcane field according to claim 5, satisfying at least one of the following conditions:
the dispersant comprises one or more of a mixture of polycarboxylate, lignosulfonate, alkyl naphthalene sulfonate, alkylphenol ethoxylate, EO/PO block polyether, polycarboxylate, alkylphenol polyoxyethylene ether formaldehyde condensate and a mixture of maleic rosin polyoxypropylene-oxylethylene ether sulfonate;
the wetting agent comprises one or more of a mixture of sodium dodecyl sulfate, fatty alcohol-polyoxyethylene ether, phenylethyl phenol polyoxyethylene ether phosphate, alkylphenol ethoxylate phosphate ester, alkyl sulfate, sodium alkylbenzene sulfonate, sodium lauryl sulfate, sodium butylnaphthalene sulphonate, fatty alcohol-polyoxyethylene ether, alkylphenol ethoxylate, alkane sulfonate, octaphenyl polyoxyethyiene and sodium diethylhexyl sulfosuccinate;
the disintegrant comprises one or more of a mixture of ammonium sulfate, sodium sulfate, sodium chloride, ammonium chloride, urea, sucrose, glucose, carboxymethyl cellulose, soluble starch and polyvinylpyrrolidone;
the adhesive comprises one or more of a mixture of polyvinyl alcohol, gel, xanthan gum, and carboxymethyl cellulose;
the emulsifier comprises one or more of a mixture of alkylphenol formaldehyde resin polyoxyethylene ether, castor oil polyoxyethylene ether, pesticide emulsifier 2201, sorbitan monostearate, polyoxyethylene sorbitan monostearate, a triphenylethylphenol polyoxypropylene block polymer, phenylethyl phenol polyoxyethylene ether, SND-1 and SND-2;
the thickener comprises one or more of a mixture of xanthan gum, gel, polyvinyl alcohol, magnesium aluminosilicate, sodium alginate, white carbon black, organobentonite, M and FT;
the antifreeze comprises one or more of a mixture of ethylene glycol, glycerol, polyethylene glycol, urea, sorbitol, and inorganic salts;
the defoamer comprises one or more of a mixture of silicone defoamers;
the filler comprises one or more of a mixture of ammonium sulfate, urea, sucrose, glucose, diatomite, kaolin, white carbon black, light calcium carbonate, talcum powder, bentonite, attapulgite and pottery clay; and
the vegetable oil comprises one or more of a mixture of soybean oil, sugarcane oil, rapeseed oil, cottonseed oil, palm oil, castor oil, corn oil, sunflower oil, isooctyl oleate, methyl oleate, and paraffin oil.

7. The compound weeding composition for a sugarcane field according to claim 5, wherein the dosage form of the compound weeding composition is at least one of suspension concentrates, oil dispersion, wettable powder or water dispersible granules.

8. The compound weeding composition for a sugarcane field according to claim 1, wherein the compound weeding composition is prepared by storing all components in a pesticide composition, forming the active ingredient, and mixing the components in a barrel separately for usage.

9. An application of the compound weeding composition for a sugarcane field according to claim 1 as a product and as an herbicide directly in pesticides.
